(19) United States
(12) Patent Application Publication
(10) Pub. No.: US 2011/0058754 A1
(43) Pub. Date: Mar. 10, 2011

(54) FILE SELECTION SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/637,639

(22) Filed: Dec. 14, 2009

(30) Foreign Application Priority Data
Sep. 8, 2009 (CN) 200910306714.4

(51) Int. Cl. G06K 9/60

(52) U.S. Cl. 382/305

(57) ABSTRACT

A file selection system includes a camera, a storage system, and a processing unit. The processing unit receives an image from the camera to find a key portion in the image, obtain coordinates of the key portion in the image, determine the coordinates of the key portion in the image to obtain a location status, and select one group of files according to the location status. The selected group of files is displayed by the electronic device.

### BACKGROUND

1. Technical Field

The present disclosure relates to a file selection system and a file selecting method.

2. Description of Related Art

Conventional media players display media with a two-dimensional appearance, regardless of a viewing angle, the media such as an image of clock looks always the same.

### BRIEF DESCRIPTION OF THE DRAWINGS

FIG. 1 is a schematic block diagram of an exemplary embodiment of a file selection system including a storage system.

FIG. 2 is a schematic block diagram of the storage system of FIG. 1.

FIGS. 3-5 are schematic diagrams of an electronic device using the file selection system of FIG. 1.

FIG. 6 is a flowchart of an embodiment of a file selecting method.

### DETAILED DESCRIPTION

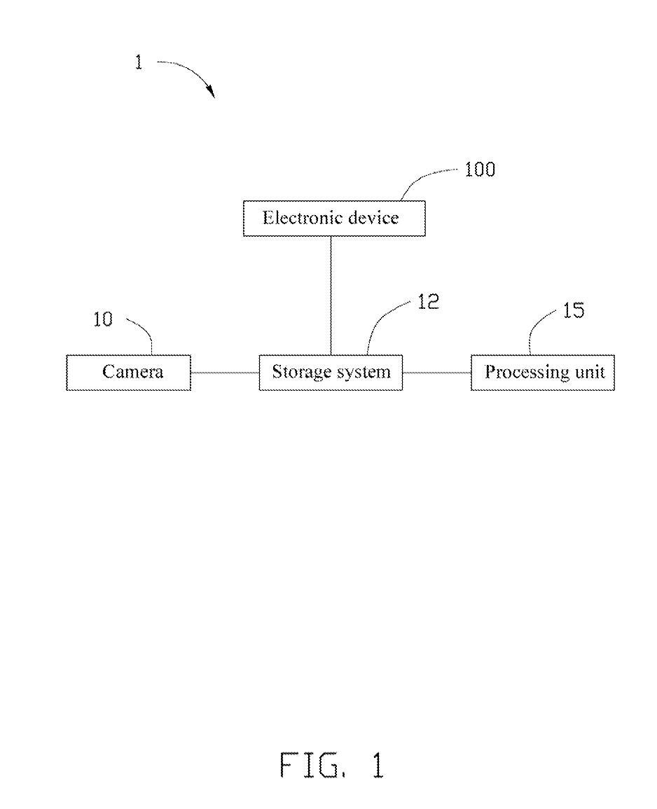

Referring to FIG. 1, an exemplary embodiment of a file selection system 1 includes a camera 10, a storage system 12, and a processing unit 15. The file selection system 1 is operable to select different image files when users look at an electronic device 100 from different angles. By changing an image to correspond to different viewpoints, a three dimensional effect is created. The electronic device 100 displays image files selected by the file selection system 1.

The camera 10 is mounted on the electronic device 100, to capture an image of a user who looks at a screen of the electronic device 100. The captured image is transmitted to the storage system 12.

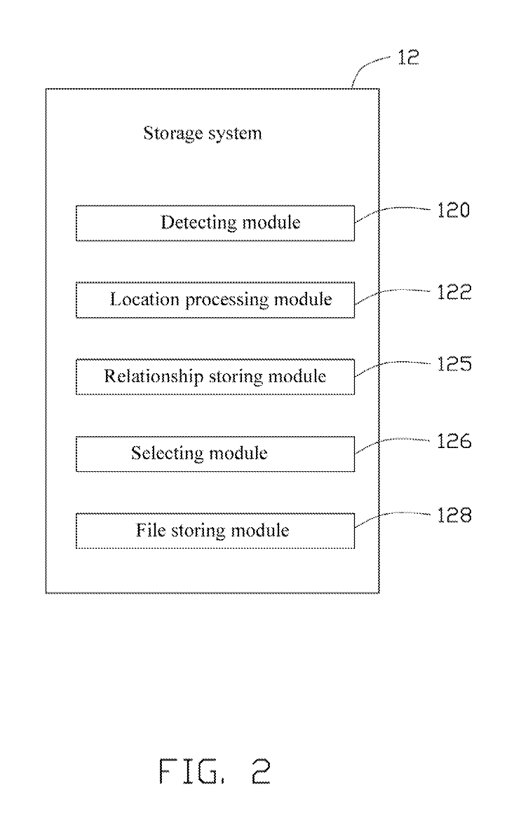

Referring to FIG. 2, the storage system 12 includes a detecting module 120, a location processing module 122, a relationship storing module 125, a selecting module 126, and a file storing module 128. The detecting module 120, the location processing module 122, and the selecting module 126 may include one or more computerized instructions and are executed by the processing unit 15.

The detecting module 120 checks the image from the camera 10 to find a key portion in the image, and to obtain information about the found key portion. In the embodiment, the detecting module 120 may be a face detecting module, and the key portion may be a face in the image. The detecting module 120 checks the image to find the face in the image, and to obtain information about the found face. It can be understood that the face detecting module uses well known facial recognition technology to find the face in the image. The information about the found face may include coordinates of the found face in the image.

The location processing module 122 determines the coordinates of the found face in the image to obtain a location relationship between the found face and the screen of the electronic device 100. The location relationship between the found face and a plane defined by viewing area of the screen of the electronic device 100 may be regarded as a location status. For example, the location processing module 122 defines a center of the found face as a first point, and a center of the screen of the electronic device 100 as a second point. An angle between a line from the first point to the second point and the plane of the screen is regarded as the location status. In other words, it is determined if the viewer is looking at the display straight on or from some angle to the left or right of the display.

The file storing module 128 stores a plurality of groups of files, such as image files, in advance. Images of an object from a particular shooting angle but respectively at different times are captured to obtain a first group of files. For example, ten images of the object are captured from 90 degrees (directly facing the object) at one for each of ten consecutive seconds, to obtain the first group of files.

The relationship storing module 125 stores a plurality of relationships between the location status and the plurality of groups of files. In other words, one group of files corresponds to one of the plurality of location statuses. For example, a location status of 90 degrees between the line from the first point to the second point and the plane of the screen, which equates to viewing the screen straight on, corresponds to the first group of files.

The selecting module 126 selects one group of the plurality of groups of files in the file storing module 128 according to the relationship storing module 125 and the location status. The selected files are displayed by the electronic device 100.

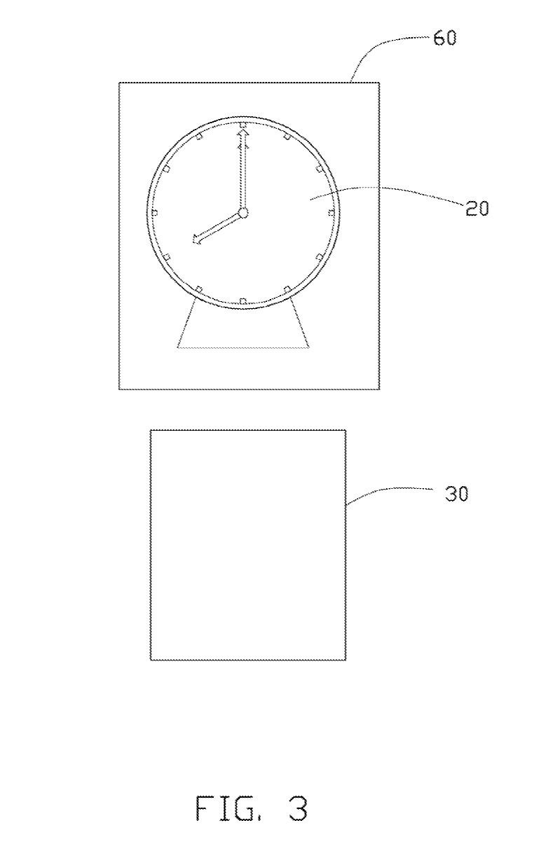

Referring to FIGS. 3-5, in the embodiment, the object is a clock 20. The clock 20 is captured from three different shooting angles, such as directly facing a front of the clock 20, obliquely facing the left side of the clock, which we will call 45 degrees left, and obliquely facing the right side of the clock 20, which we will call 45 degrees right, to obtain three groups of images. Images obtained from 90 degrees compose a first group of images 60. Images obtained from 45 degrees left compose a second group of images 50. Images obtained from 45 degrees right compose a third group of images 70. In this embodiment, the clock 20 has a second hand, and image of the clock is captured each second for a full minute to acquire sixty images from each angle from 8:00:00 to 8:00:59 for example. Thus three groups of images are acquired that can be used to display a dynamic image of a clock that can be viewed from different angles to give the illusion of three dimensions.

The detecting module 120 checks an image 30 from the camera 10 to find a face in the image 30. In FIG. 3, there is no face in the image 30. The selecting module 126 selects the first group of images 60 to show the clock 20 ticking off the seconds from straight ahead by going through the images once each second.

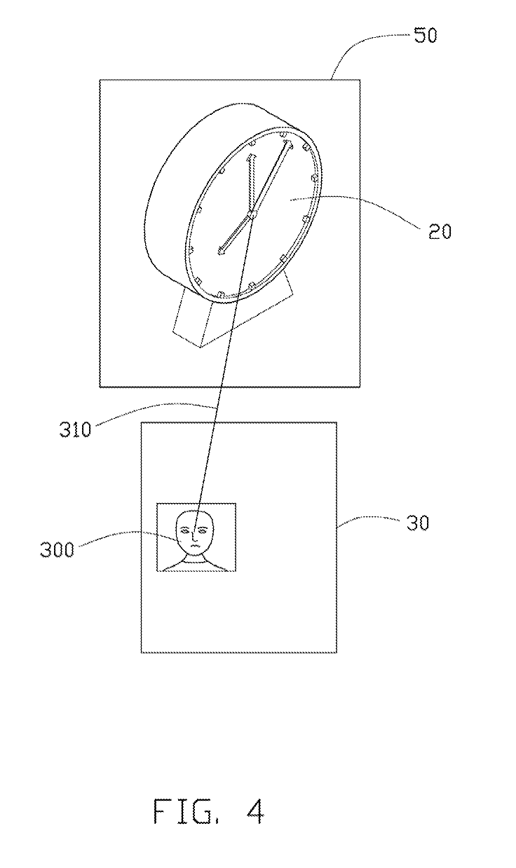

In FIG. 4, there is a face 300 in the image 30. The location processing module 122 determines the coordinates of the found face 300 in the image 30 to obtain a location status of 45 degrees left. In other words, an angle between the line 310 from the first point to the second point and the plane of the screen of the electronic 100 is 45 degrees left. Thus the face 300 is to the left of the screen of the electronic device 100. The selecting module 126 selects the second group of images 50 according to the location status and the relationship storing module 125. The second group of images 50 is displayed by the electronic device 100. Thus to the user viewing the screen he or she sees the clock 20 in quarter profile from the left.

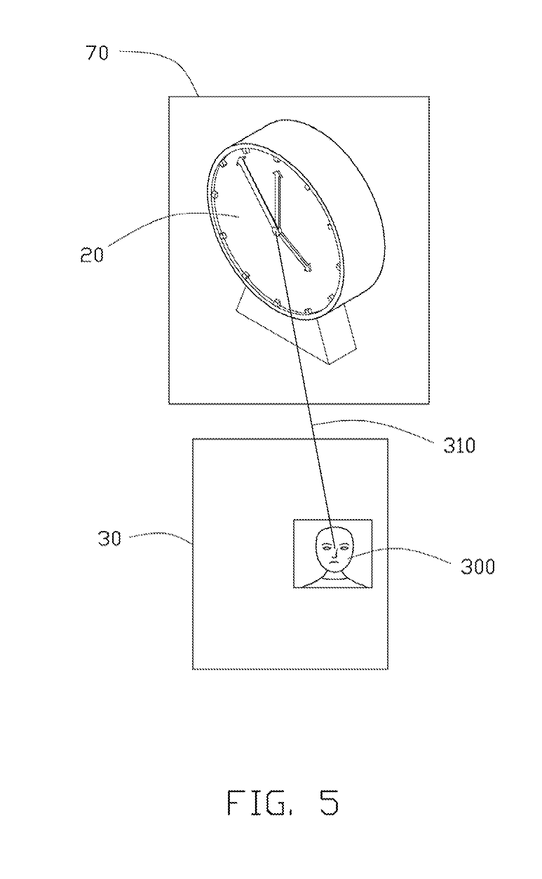

In FIG. 5, the face 300 is at the right of the image 30. The location processing module 122 determines the coordinates of the found face 300 in the image 30 to obtain a location status of 45 degrees right. In other words, an angle between the line 310 from the first point to the second point and the plane of the screen of the electronic device 100 is 45 degrees right. Thus the face 300 is to the right of the screen of the electronic device 100. The selecting module 126 selects the third group of images 70 according to the location status and the relationship storing module 125. The third group of images 70 is displayed by the electronic device 100. Thus to the user viewing the screen he or she sees the clock 20 in quarter profile from the right.

In addition, upon the condition that the detecting module 120 found the face 300 at the right of the image 30 when the electronic device 100 is displaying the first group of images 60, the selecting module 126 selects an image in the third group of images 70 which is at a next time. For example, when the electronic device 100 is displaying an image of the first group at 8:00:50 P.M., the detecting module 120 finds the face 300 at the right of the image 30. As a result, the selecting module 126 selects an image of the third group at 8:00:51 P.M. The selected image is displayed by the electronic device 100.

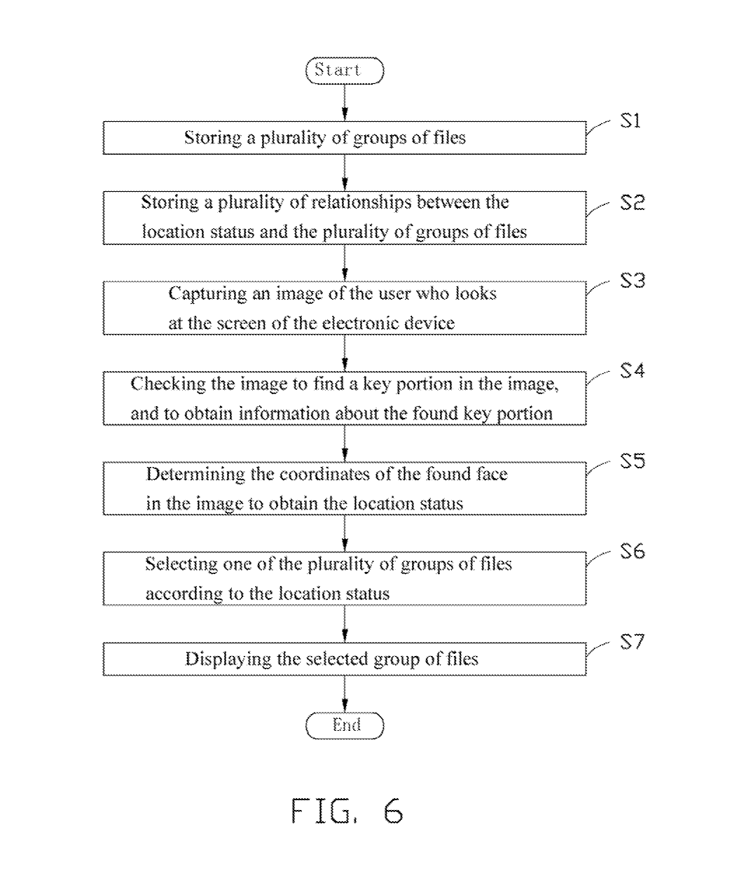

Referring to FIG. 6, an exemplary embodiment of a file selecting method includes the following steps.

In step S1, a plurality of groups of files is stored in the file storing module 128. Images of the clock 20 from a particular shooting angle but respectively at different times are captured to obtain a first group of files. For example, ten images of the clock 20 are captured from 90 degrees one for each of ten consecutive seconds, to obtain the first group of files.

In step S2, a plurality of relationships between the location status and the plurality of groups of files are stored in the relationship storing module 125. In other words, one group of files corresponds to a location status. For example, a location status of 90 degrees between the line from the center of the face to the center of the image and the plane of the screen of the electronic device 100 corresponds to the first group of files.

In step S3, the camera 10 captures images of the user who looks at the screen of the electronic device 100.

In step S4, the detecting module 120 checks the image from the camera 10, to find a key portion in the image, and to obtain information about the found key portion. In the embodiment, the detecting module 120 may be a face detecting module. The key portion may be a face in the image. The detecting module 120 checks the image to find the face in the image, and to obtain information about the found face. It can be understood that the face detecting module uses well known facial recognition technology to find the face in the image. The information about the found face may include coordinates of the found face in the image.

In step S5, the location processing module 122 determines the coordinates of the found face in the image to obtain the location status. For example, the location processing module 122 defines the center of the found face as the first point, and the center of the screen of the electronic device 100 as the second point. An angle between the line from the first point to the second point and the plane of the screen of the electronic device 100 is regarded as the location status.

In step S6, the selecting module 126 selects one of the plurality of groups of files in the file storing module 128 according to the relationship storing module 125 and the location status.

In step S7, the selected group of files are displayed by the electronic device 100.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A file selection system comprising:
a camera to capture an image;
a processing unit; and
a storage system connected to the processing unit and storing a plurality of modules to be executed by the processing unit, wherein the plurality of modules comprise:
a detecting module to receive the image from the camera to find a key portion in the image, and obtain coordinates of the key portion in the image;
a location processing module to determine the coordinates of the key portion in the image to obtain a location status, wherein the location status is a location relationship between the key portion and a plane defined by viewing area of a screen of an electronic device;
a selecting module to select a group of files from a plurality of groups of files with different shooting angles according to the location status, wherein the selected files are displayed by the electronic device.

2. The file selection system of claim 1, wherein the storage system further comprises a file storing module, the plurality of groups of files with different shooting angles are stored in the file storing module.

3. The file selection system of claim 1, wherein the storage system further comprises a relationship storing module, the relationship storing module stores a plurality of relationships between the location status and the plurality of groups of images.

4. The file selection system of claim 1, wherein the key portion is a face.

5. The file selection system of claim 1, wherein the location relationship between the key portion and the electronic device is an angle between a line from a center of the key portion to a center of a screen of the electronic device and the plane of the screen of the electronic device.

6. The file selection system of claim 1, wherein each group of files comprises a plurality of files being captured at different times.

7. The file selection system of claim 7, wherein upon the condition that the detecting module finds the key portion in the image when the electronic device is displaying one group of files, the selecting module selects a file in another group of files which is shoot at a next time.

8. A file selecting method comprising:
capturing an image;
detecting the image to find a key portion in the image, and to obtain information about the key portion;
determining coordinates of the key portion in the image to obtain a location status, wherein the location status is a location relationship between the key portion and a plane defined by viewing area of a screen of an electronic device; and
selecting one group of files from a plurality of groups of files according to the location status correspondingly.

9. The file selecting method of claim 8, wherein the key portion is a face.

10. The file selecting method of claim 8, wherein the location relationship between the key portion and the electronic device is an angle between a line from a center of the key portion to a center of a screen of the electronic device and the plane of the screen of the electronic device.

11. The file selecting method of claim 8, wherein each group of files comprises a plurality of files being shoot at different times.

12. The file selecting method of claim 11, wherein upon the condition that the key portion is found in the image when the electronic device is displaying one group of files, a file in another group which is captured at a next time is selected.

13. The file selecting method of claim 8, before capturing the image comprising:
storing a plurality of groups of files in a storage system; and
storing a plurality of relationships between the location status and the plurality of groups of files in the storage system.
